(19) United States
(12) Patent Application Publication
(10) Pub. No.: US 2023/0206533 A1
(43) Pub. Date: Jun. 29, 2023

(54) EMOTIVE AVATAR ANIMATION WITH COMBINED USER POSE DATA

(71) Applicant: Hewlett-Packard Development Company, L.P., Spring, TX (US)

(72) Inventors: Robert Paul Martin, Fort Collins, CO (US); Mark A. Lessman, Fort Collins, CO (US)

(73) Assignee: Hewlett-Packard Development Company, L.P., Spring, TX (US)

(21) Appl. No.: 18/000,329

(22) PCT Filed: Jun. 18, 2020
(86) PCT No.: PCT/US2020/038367

§ 371 Date: Nov. 30, 2022

(51) Int. Cl. G06T 13/40; G06T 7/73; G06V 40/20; G06V 40/16; G02B 27/00

(52) U.S. Cl. CPC G06T 13/40; G06T 7/73; G06V 40/20; G06V 40/176; G02B 27/0093

(57) ABSTRACT

Examples of a method for emotive avatar animation are described. Some examples of the method may include combining first user pose data captured by an external camera with second user pose data captured by a head-mounted display (HMD). Some examples of the method may include animating an emotive avatar based on the combined user pose data.

### BACKGROUND

Computing devices may be used to perform computing tasks. For example, computing devices may be employed to communicate with other computing resources in a network environment.

### BRIEF DESCRIPTION OF THE DRAWINGS

Various examples will be described below by referring to the following figures.

FIG. 1 illustrates an example of a computing device for animating an emotive avatar based on combined user pose data;

FIG. 2 is a flow diagram illustrating an example method for animating an emotive avatar with combined user pose data;

FIG. 3 is a diagram illustrating a remote computing device and a head-mounted display (HMD) for animating an emotive avatar with combined user pose data; and

FIG. 4 is a flow diagram illustrating another example method for animating an emotive avatar with combined user pose data.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations in accordance with the description; however, the description is not limited to the examples and/or implementations provided in the drawings.

### DETAILED DESCRIPTION

The techniques described herein relate to animating an emotive avatar in a virtual reality (VR) or augmented reality (AR) context. A computing device may communicate with other devices through a network. Some examples of computing devices include desktop computers, laptop computers, tablet computers, mobile devices, smartphones, head-mounted display (HMD) devices, gaming controllers, internet-of-things (IoT) devices, autonomous vehicle systems, robotic devices (e.g., manufacturing, robotic surgery, search and rescue, firefighting).

With the advance of technology and several social and societal trends converging, collaboration in VR and/or AR environments is becoming more popular. For example, a user may participate in a remote video conference by wearing a VR or AR headset (referred to herein as an HMD). In this emerging medium, expressiveness and emotiveness is highly prized. In some approaches, the expressiveness of a user in a VR or AR application may be provided by an emotive avatar of the user. As used herein, an “avatar” is a graphical representation of a user. The avatar may be rendered in human form or in other forms (e.g., animal, mechanical, abstract, etc.). In some examples, an avatar may be animated to convey movement. For example, the facial elements (e.g., eyes, mouth, jaw, head position, etc.) of the avatar may change to create an illusion of movement. An emotive avatar may be animated to convey emotions based on the user's expressions (e.g., facial expressions, body movement, etc.).

Facial expressions may be difficult to capture in VR and AR for various reasons including occlusion of parts of the face by the equipment (e.g., HMD) or the limitations of the VR/AR equipment. In some examples, an HMD may include a camera to observe a portion of the user's face (e.g., eyes). These cameras may be used to capture some expressions of the user, but their utility may be limited by their potential placements (e.g., near the user's face) and their resulting field of view and angle of coverage. In other examples, an HMD may not have cameras to view the user.

In some examples, it may be difficult to get a good angle on the human face to capture expression from a head-worn device (e.g., HMD). For example, as the form factors of such devices shrink, a camera located on the head-worn device may be in very close proximity to the user's face.

The examples described herein may utilize other local devices with cameras to augment what can be obtained with the head-worn device. For example, an external camera may provide a higher-quality capture of the expressiveness of the user's face. This will result in a more expressive interaction in virtual space.

Examples of systems and methods for augmenting an emotive (e.g., expressive) avatar for VR and/or AR applications using an external camera are described herein. The external camera may be located at a device (e.g., laptop, mobile phone, PC-connected monitor, etc.) that is remote from the HMD worn by the user.

User pose data (e.g., facial expressions, torso position, head position) of a user may be captured using a camera of a remote external computing device (e.g., personal computer, laptop computer, smartphone, monitor webcam, etc.). User pose data may also be captured by an HMD worn by the user. The captured user pose data may be combined and analyzed by an application running on a computing device. For example, control points of the user may be calculated from the user pose data captured by the external camera. The observed control points may be combined with pose data captured by the HMD for animating and/or driving the emotive avatar.

The examples described herein may also track the relative location, position and/or movement of the upper body (e.g., torso, shoulders, lower face) of the user for data integration. The combined user pose data is then utilized for driving the avatar.

In some examples, the emotive avatar animation described herein may be performed using machine learning. Examples of the machine learning models described herein may include neural networks, deep neural networks, spatio-temporal neural networks, etc. For instance, model data may define a node or nodes, a connection or connections between nodes, a network layer or network layers, and/or a neural network or neural networks. Examples of neural networks include convolutional neural networks (CNNs) (e.g., basic CNN, deconvolutional neural network, inception module, residual neural network, etc.) and recurrent neural networks (RNNs) (e.g., basic RNN, multi-layer RNN, bi-directional RNN, fused RNN, clockwork RNN, etc.). Some approaches may utilize a variant or variants of RNN (e.g., Long Short Term Memory Unit (LSTM), peephole LSTM, no input gate (NIG), no forget gate (NFG), no output gate (NOG), no input activation function (NIAF), no output activation function (NOAF), no peepholes (NP), coupled input and forget gate (CIFG), full gate recurrence (FGR), gated recurrent unit (GRU), etc.). Different depths of a neural network or neural networks may be utilized.

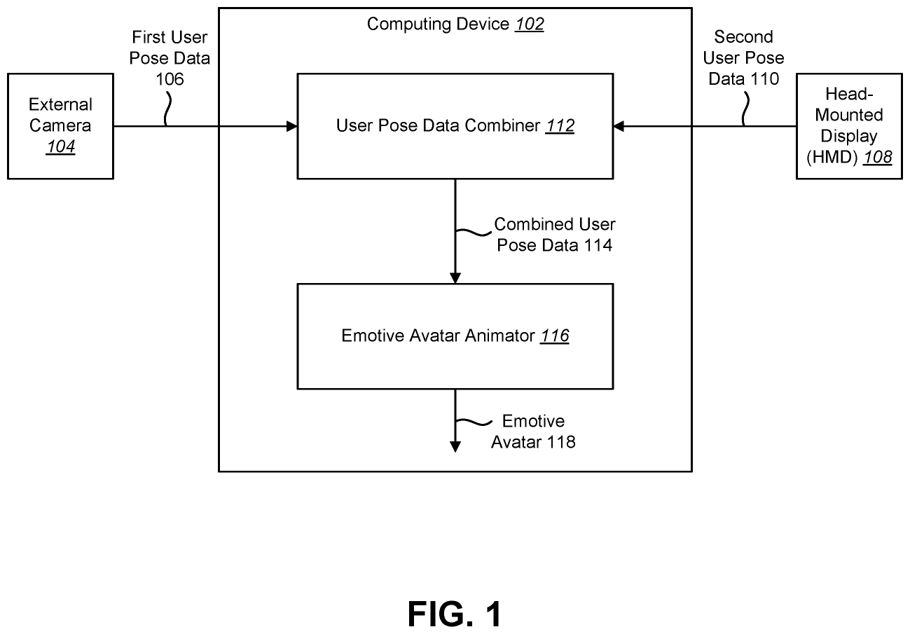

FIG. 1 illustrates an example of a computing device 102 for animating an emotive avatar 118 based on combined user pose data 114. In some examples, the computing device 102 may be used in a VR or AR application.

In some examples, the computing device 102 may be a personal computer, a laptop computer, a smartphone, a computer-connected monitor, a tablet computer, a gaming controller, etc. In other examples, the computing device 102 may be implemented by a head-mounted display (HMD) 108.

The computing device 102 may include and/or may be coupled to a processor and/or a memory. In some examples, the memory may include non-transitory tangible computer-readable medium storing executable code. In some examples, the computing device 102 may include a display and/or an input/output interface. The computing device 102 may include additional components (not shown) or some of the components described herein may be removed and/or modified without departing from the scope of this disclosure.

The computing device 102 may include a user pose data combiner 112. For example, the processor of the computing device 102 may execute code to implement the user pose data combiner 112. The user pose data combiner 112 may receive first user pose data 106 captured by an external camera 104. In some examples, the first user pose data 106 may include an upper body gesture of the user. This may include a gesture of the face, upper torso, arms, and/or hands of the user. The user pose data combiner 112 may also receive second user pose data 110 captured by the HMD. Examples of formats for the first user pose data 106 and the second user pose data 110 are described below.

In some examples, the external camera 104 may capture digital images. For example, the external camera 104 may be a monocular (e.g., single lens) camera that captures still images and/or video frames. In other examples, the external camera 104 may include multiple (e.g., 2) lenses for capturing stereoscopic images. In yet other examples, the external camera 104 may be a time-of-flight camera (e.g., LIDAR) that can obtain distance measurements for objects within the field of view of the external camera 104.

In some examples, the external camera 104 is external to the HMD 108. In other words, the external camera 104 may be physically separated from the HMD 108. The external camera 104 may face the user wearing the HMD 108 such that the face and upper torso of the user is visible to the external camera 104.

In other examples, the external camera 104 may be connected to the HMD 108, but may be positioned far enough away from the user to be able to observe the lower face and upper torso of the user. For example, the external camera 104 may be mounted at one end of an extension component that is connected to the HMD 108. The extension component may place the external camera 104 a certain distance away from the main body of the HMD 108.

In some examples where the computing device 102 is separate from the HMD 108, the external camera 104 may be included in the computing device 102 (e.g., laptop computer, desktop computer, smartphone, etc.). For instance, the external camera 104 may be a webcam located on the monitor of a laptop computer or may be a camera of a smartphone.

In other examples, the computing device 102 may be implemented on the HMD 108. In this case, the external camera 104 may be located on a remote computing device that is in communication with the computing device 102 located on the HMD 108.

In yet other examples, the computing device 102 may be separate from the HMD 108 and the external camera 104 may also be separate from the computing device 102. In this case, the computing device 102 may be in communication with both the remote HMD 108 and the external camera 104.

In some examples, the first user pose data 106 captured by the external camera 104 may include an upper body gesture of the user. For instance, the upper body gesture may include the position and/or movement of the user's shoulders. The external camera 104 may observe shoulder shrugs or arm movement.

In some examples, the first user pose data 106 may include a facial expression of the user. For example, the external camera 104 may observe the lower portion the user's face. In this case, the external camera 104 may capture the position and movement of the mouth, chin, jaw, tongue, etc. of the user. The external camera 104 may also capture movement of the user's head relative to the external camera 104. This may capture a nod (e.g., affirmative or negative nod) of the user.

In the case of AR, the external camera 104 may observe and capture eye movement and/or other expressions of the upper portion of a user's face. For example, the external camera 104 may be able to view the user's eyes and/or eyebrows through the glass of an AR HMD 108.

In some examples, the external camera 104 may provide the first user pose data 106 to the user pose data combiner 112 in the form of a digital image. For example, the external camera 104 may send frames of a video stream to the computing device 102. The digital image may include an upper body gesture of the user and/or a facial expression of the user. The computing device 102 may then perform a computer vision operation to detect user pose features in the first user pose data 106. For example, the computing device 102 may perform object recognition and/or tracking to determine the location of certain features of the face (e.g., mouth, lips, eyes (if observable), chin, etc.) and upper torso (e.g., shoulders, neck, arms, hands, etc.). The computing device 102 may obtain control points for the features detected in the object recognition operation.

In other examples, the external camera 104 may provide the first user pose data 106 to the user pose data combiner 112 in the form of control points. For instance, the external camera 104 may analyze the facial images for facial control points or other foundational avatar information (e.g., torso control points). This analysis may include object recognition and/or tracking operations. As used herein, a user pose control point is a point corresponding to a feature on a user. For example, a control point may mark a location of a user's body (e.g., mouth, chin, shoulders, etc.). Multiple control points may represent a user's pose.

In some examples where the external camera 104 is a stereoscopic camera or time-of-flight camera, the external camera 104 may measure three-dimensional (3D) control points. For example, the time-of-flight camera may provide a 3D point cloud of the user. In another example, depth measurements of various points of the user may be determined from the stereoscopic camera.

The external camera 104 may communicate the control points to the computing device 102. This may result in a small amount of information (e.g., the control points) that is transmitted between the external camera 104 and the computing device 102. This may reduce latency and processing times when the computing device 102 is implemented on the HMD 108 or other computing resource.

In some examples, the external camera 104 (or a computing device connected to the external camera 104) may track the HMD 108 or the user wearing HMD 108. For example, the external camera 104 may track the user and capture facial images of the user wearing the HMD 108.

In some examples, the second user pose data 110 captured by the HMD 108 may include orientation data of the HMD 108. For example, the HMD 108 may include an inertial sensor or other sensor to determine the orientation of the HMD 108. In some examples, the orientation of the HMD 108 may be a six-degree-of-freedom (6doF) pose of the HMD 108. The orientation of the HMD 108 may be used by the computing device 102 to determine the position of the user's head.

In some examples, the second user pose data 110 may include eye tracking data of the user. For instance, the HMD 108 may include a camera to view the eyes of the user. It should be noted that the camera of the HMD 108 is separate from the external camera 104. The camera of the HMD 108 may track eye movement. For example, in the case of VR, the eyes of the user may be obscured by the body of the HMD 108. The eye movement data observed by the camera of the HMD 108 may be provided to the computing device 102 as second user pose data 110. It should be noted that because of the location of the camera of the HMD 108 (e.g., enclosed within the HMD 108 and near the face of the user), the camera of the HMD 108 may not observe the lower face and upper torso of the user.

In other examples, the second user pose data 110 may include biometric data of the user. For example, the HMD 108 may include an electromyography (EMG) sensor to analyze facial muscle movements of the user. In the case that the computing device 102 is separate from the HMD 108, the EMG sensor data may be provided to the computing device 102 as second user pose data 110.

The user pose data combiner 112 may receive the first user pose data 106 and the second user pose data 110. The user pose data combiner 112 may combine the first user pose data 106 captured by the external camera 104 with the second user pose data 110 captured by the HMD 108. In some examples, the user pose data combiner 112 may track the HMD 108 relative to the external camera 104. The user pose data combiner 112 may calculate facial gestures and upper body movement control points from the first user pose data 106. For example, the user pose data combiner 112 may use computer vision and/or machine learning to detect the user pose control points in the first user pose data 106 captured by the external camera 104. In another example, the user pose data combiner 112 may receive the user pose control points from the external camera 104.

The user pose data combiner 112 may merge the first user pose data 106 with the second user pose data 110. For example, the user pose data combiner 112 may apply a rotation and translation matrix to the first user pose data 106 captured by the external camera 104 with respect to the second user pose data 110 of the HMD 108. The rotation and translation matrix may orient the first user pose data 106 in the coordinate system of the second user pose data 110. In other words, the rotation and translation matrix may convert the first user pose data 106 from the perspective of the external camera 104 to the perspective of the HMD 108.

In some examples, the user pose data combiner 112 may generate a unified facial and upper body model of the user based on the combined user pose data 114. For instance, the combined user pose data 114 may merge control points obtained from the external camera 104 with the second user pose data 110 (e.g., eye tracking data, biometric data) captured by the HMD 108 to form a single model of the user's pose. This synthesized model may be referred to as a unified facial and upper body model. In some examples, the unified facial and upper body model may be the combined user pose data 114 generated by the user pose data combiner 112. It should be noted that in addition to facial control points, the unified facial and upper body model may also include control points for the upper torso of the user. Therefore, the user pose data combiner 112 may synthesize control points for a holistic emotive avatar model.

The computing device 102 may also include an emotive avatar animator 116. For example, the processor of the computing device 102 may execute code to implement the emotive avatar animator 116. The emotive avatar animator 116 may receive the combined user pose data 114. The emotive avatar animator 116 may animate an emotive avatar 118 based on the combined user pose data 114. In some examples, the emotive avatar animator 116 may change an expression of the emotive avatar 118 based on the combined user pose data 114. The animated emotive avatar 118 may be used to create a visual representation of the user in a VR application or AR application.

In some examples, the emotive avatar animator 116 may use the unified facial and upper body model of the user to modify a model of the emotive avatar 118. For example, the user pose control points of the unified facial and upper body model may be mapped to control points of the emotive avatar model. The emotive avatar animator 116 may change the control points of the emotive avatar model based on changes in the control points of the unified facial and upper body model. For instance, if the external camera 104 observes that the user frowns, the emotive avatar animator 116 may cause the emotive avatar 118 to frown based on the captured user pose control points.

In the examples described herein, the external camera 104 (e.g., located on a PC Laptop, monitor with camera, smartphone, etc.) can be used to augment the capture of the person in VR or AR to provide better face tracking and upper body movement tracking for use in animating the emotive avatar 118. This may be useful in VR and AR where it is difficult or impossible to position cameras on an HMD 108 to look at the lower part of the user's face as the displays tend to be close to the face. The external camera 104 may provide the lower face and upper torso information. Also, the described examples may provide user pose data for VR and AR applications as the shape of HMDs 108 become thinner over time.

In some examples, the processor of the computing device 102 may determine a position of the HMD 108 relative to the external camera 104 based on a displayed fiducial. For example, the external camera 104 may be included in a remote computing device. The fiducial may be a marker (e.g., barcode, symbol, emitted light, etc.) that is displayed by the remote computing device to assist in orienting the HMD 108 to the external camera 104. The HMD 108 may include a camera to view the fiducial and determine the location and/or orientation of the HMD 108 relative to the external camera 104. This may further aid the computing device 102 in accurately combining the first user pose data 106 from the external camera 104 with the second user pose data 110 provided by the HMD 108. For example, a rotation and translation matrix may be updated based on the location data obtained by observing and tracking the fiducial.

In some examples, the remote computing device may generate the fiducial. For instance, the remote computing device may display the fiducial on a screen that is viewable by the HMD camera. In other approaches, the remote computing device may emit a light (e.g., infrared light) that is detected by the HMD 108.

In other examples, the fiducial may be a fixed marker located on the remote computing device. For example, the fiducial may be a barcode or other symbol that is located on the remote computing device.

In yet other examples, the shape of the remote computing device housing the external camera 104 may function as the fiducial. For example, the HMD 108 may detect the shape of a laptop computer with the external camera 104.

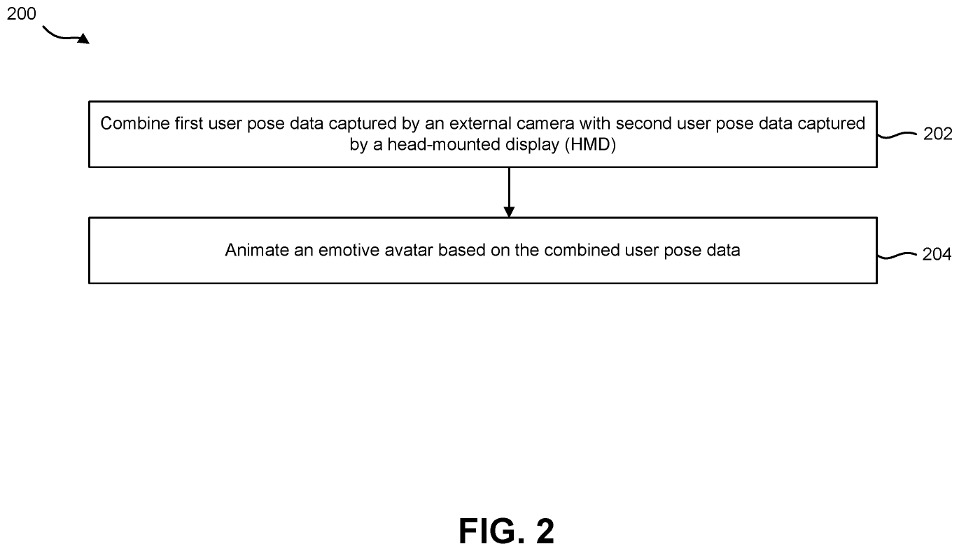

FIG. 2 is a flow diagram illustrating an example method 200 for animating an emotive avatar 118 with combined user pose data 114. The method 400 may be implemented by a computing device 102.

The computing device 102 may combine 202 first user pose data 106 captured by an external camera 104 with second user pose data 110 captured by an HMD 108. The external camera 104 may be physically separated from the HMD 108. For example, the external camera 104 may be located on a laptop computer, mobile device (e.g., smartphone, tablet computer) or a monitor connected to a personal computer.

In some examples, the first user pose data 106 captured by the external camera 104 may include an upper body gesture of the user. In other examples, the first user pose data 106 may include a facial expression of the user.

In some examples, the second user pose data 110 captured by the HMD 108 may include orientation data of the HMD 108. In other examples, the second user pose data 110 may include eye tracking data or biometric data of the user captured by the HMD 108.

In some examples, combining 202 the first user pose data 106 with the second user pose data 110 may include applying a rotation and translation matrix to the first user pose data 106 with respect to the second user pose data 110 of the HMD 108. For example, the rotation and translation matrix may convert the first user pose data 106 to the perspective of the HMD 108.

In some examples, the computing device 102 may detect user pose control points in the first user pose data 106. The computing device 102 may then combine the detected user pose control points with the second user pose data 110 captured by the HMD 108. For example, the computing device 102 may apply a rotation and translation matrix to the user pose control points of the first user pose data 106 to convert the control points to the coordinate system of the second user pose data 110. The converted control points may be merged with control points from the second user pose data 110 to generate a unified facial and upper body model of the user.

The computing device 102 may animate 204 an emotive avatar 118 based on the combined user pose data 114. For example, the computing device 102 may change an expression of the emotive avatar based on the combined user pose data 114. The animated emotive avatar 118 may be used in to create a visual representation of the user in a VR application or AR application.

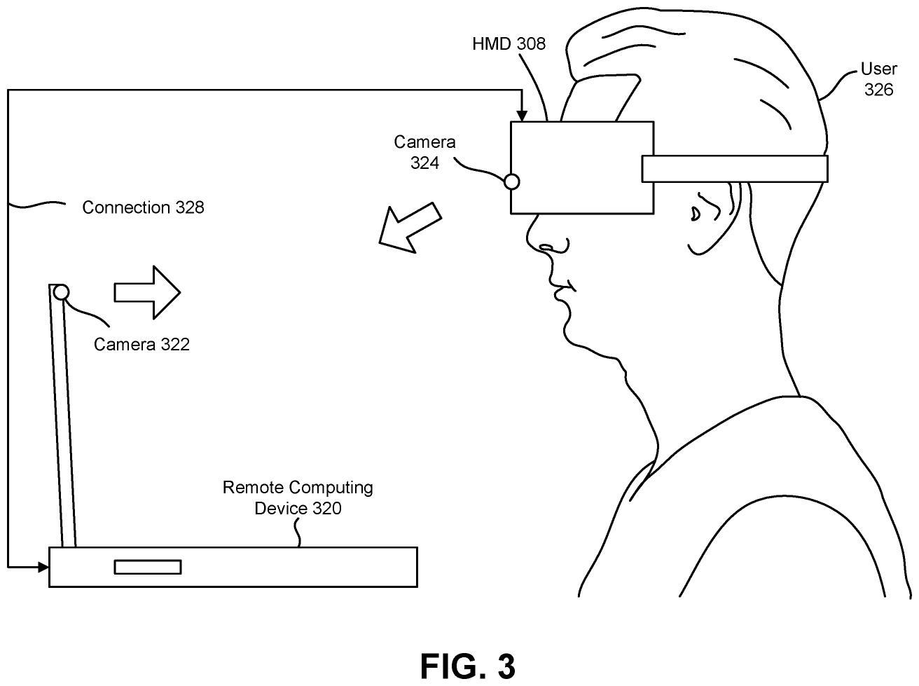

FIG. 3 is a diagram illustrating a remote computing device 320 and an HMD 308 for animating an emotive avatar with combined user pose data. In this example, the remote computing device 320 is a laptop computer. It should be noted that in other examples, the remote computing device 320 may be a mobile device (e.g., smartphone, tablet computer, etc.), a monitor attached to a personal computer or other type of computing device.

The remote computing device 320 includes a camera 322. For example, the camera 322 may be a webcam located in the bezel of the laptop display. The camera 322 may be implemented in accordance with the external camera 104 of FIG. 1.

The remote computing device 320 may communicate with the HMD 308 over a connection 328. For example, the connection 328 may be communication link that is established between the remote computing device 320 and the HMD 308 worn by a user 326. The connection 328 may be wired or wireless.

The camera 322 of the remote computing device 320 may be positioned to capture user pose data. For example, the camera 322 may view the face and upper torso of the user. It should be noted that in FIG. 3, the camera 322 is positioned to see the head, neck and shoulder area of the user 326. However, the camera 322 may also be positioned to view more of the upper torso of the user 326 (e.g., the arms, hands, chest area, etc.).

In some examples, the camera 322 may be a monoscopic camera, a stereoscopic camera and/or a time-of-flight camera. In some examples, the camera 322 may include a single lens or multiple lenses. The camera 322 and/or the remote computing device 320 may determine control points from the observed face and upper torso of the user. The control points may be two-dimensional (2D) or 3D control points.

In some examples, the camera 322 and the remote computing device 320 may perform facial tracking to detect the face of the user 326 to capture user pose data. In other examples, the camera 322 and the remote computing device 320 may track the HMD 308 to capture user pose data.

The HMD 308 may also capture user pose data. For example, a camera (not shown) in the HMD 308 may track eye movements of the user 326. In some examples, the HMD 308 may include biometric sensors (e.g., EMG sensors) to detect movement of the user's face.

The user pose data captured by the camera 322 of the remote computing device 320 may be combined to animate an emotive avatar. This may be accomplished as described in FIGS. 1 and 2.

In some examples, the remote computing device 320 may display a fiducial to improve tracking by the HMD 308. For example, the HMD 308 may include a camera 324 to observe and track the fiducial of the remote computing device 320. By determining the location of the HMD 308 relative to the remote computing device 320, the user pose data captured by the camera 322 of the remote computing device 320 may be combined with the user pose data of the HMD 308 more accurately.

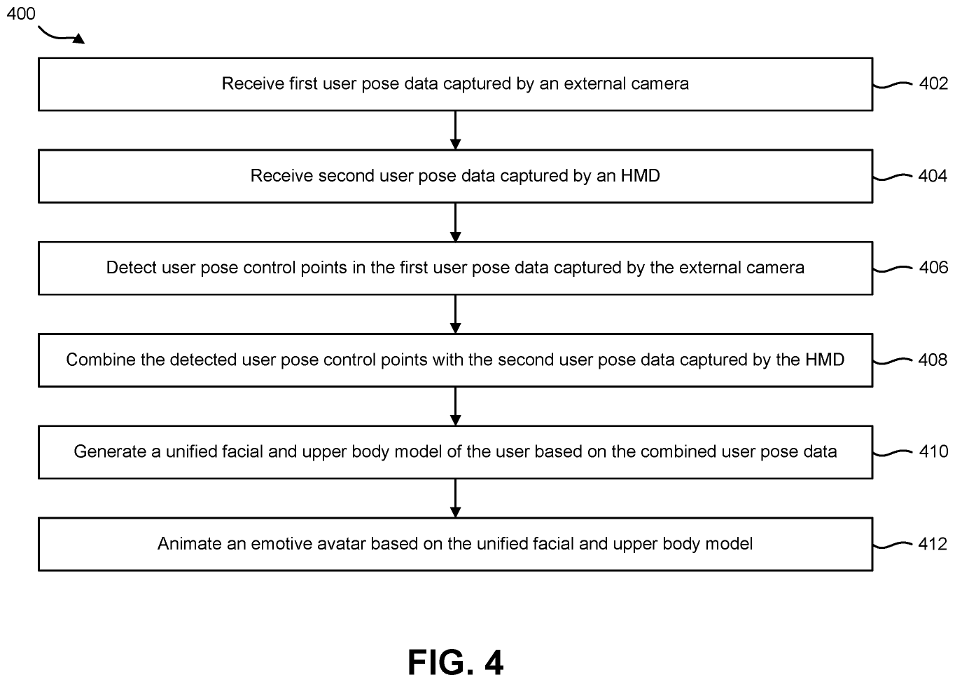

FIG. 4 is a flow diagram illustrating another example method 400 for animating an emotive avatar 118 with combined user pose data 114. The method 400 may be implemented by a computing device 102.

The computing device 102 may receive 402 first user pose data 106 captured by an external camera 104. The computing device 102 may also receive 404 second user pose data captured by an HMD 108.

The computing device 102 may detect 406 user pose control points in the first user pose data 106 captured by the external camera 104. For example, the computing device 102 may analyze facial images captured by the external camera 104 for user pose control points. In other examples, the external camera 104 may detect the user pose control points and may send the user pose control points to the computing device 102.

The computing device 102 may combine 408 the detected user pose control points with the second user pose data 110 captured by the HMD 108. In some examples, the second user pose data 110 may include user pose control points. For instance, eye tracking and/or biometric sensors of the HMD 108 may generate user pose control points. In some examples, the HMD 108 may also generate control points from orientation data captured by inertial sensors. The computing device 102 may apply a rotation and translation matrix to the user pose control points captured by the external camera 104 to convert these control points to the perspective of the HMD 108.

The computing device 102 may generate 410 a unified facial and upper body model of the user based on the combined user pose data 114. For example, the unified facial and upper body model may include the merged user pose control points from the external camera 104 and the HMD 108. In some examples, the unified facial and upper body model may include lower facial control points and torso control points captured by the external camera 104. The unified facial and upper body model may also include control points captured by sensors (e.g., eye tracking camera(s), EMG sensor(s) and/or inertial sensor(s), etc.) of the HMD 108.

The computing device 102 may animate 412 an emotive avatar 118 based on the unified facial and upper body mode. For example, the user pose control points of the unified facial and upper body model may be mapped to control points of a model of the emotive avatar 118. The computing device 102 may change the control points of the emotive avatar model based on changes in the control points of the unified facial and upper body model. The animated emotive avatar 118 may be used as a visual representation of the user in a VR application or AR application.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
combining first user pose data captured by an external camera with second user pose data captured by a head-mounted display (HMD); and
animating an emotive avatar based on the combined user pose data.

2. The method of claim 1, wherein the first user pose data captured by the external camera comprises an upper body gesture of the user.

3. The method of claim 1, wherein the first user pose data captured by the external camera comprises a facial expression of the user.

4. The method of claim 1, further comprising:
detecting user pose control points in the first user pose data captured by the external camera; and
combining the detected user pose control points with the second user pose data captured by the HMD.

5. The method of claim 1, further comprising generating a unified facial and upper body model of the user based on the combined user pose data.

6. The method of claim 5, wherein the emotive avatar is animated based on the unified facial and upper body model.

7. The method of claim 1, wherein the emotive avatar comprises a visual representation of the user in a virtual reality application or augmented reality application.

8. A computing device, comprising:
a memory;
a processor coupled to the memory, wherein the processor is to:
receive first user pose data captured by an external camera;
receive second user pose data captured by a head-mounted display (HMD);
combine the first user pose data captured by the external camera with the second user pose data captured by the HMD; and
animate an emotive avatar based on the combined user pose data.

9. The computing device of claim 8, wherein the external camera is physically separated from the HMD.

10. The computing device of claim 8, wherein the second user pose data captured by the HMD comprises orientation data of the HMD.

11. The computing device of claim 8, wherein the second user pose data captured by the HMD comprises eye tracking data or biometric data of the user.

12. A non-transitory tangible computer-readable medium storing executable code, comprising:
code to cause a processor to receive first user pose data captured by an external camera of a remote computing device;
code to cause the processor to receive second user pose data captured by a head-mounted display (HMD);
code to cause the processor to combine the first user pose data captured by the external camera with the second user pose data captured by the HMD; and
code to cause the processor to animate an emotive avatar based on the combined user pose data.

13. The computer-readable medium of claim 12, wherein the code to cause the processor to combine the first user pose data captured by the external camera of the remote computing device with the second user pose data captured by the HMD comprises code to cause the processor to apply a rotation and translation matrix to the first user pose data captured by the external camera with respect to the second user pose data of the HMD.

14. The computer-readable medium of claim 12, wherein the code to cause the processor to animate the emotive avatar based on the combined user pose data comprises code to cause the processor to change an expression of the emotive avatar based on the combined user pose data.

15. The computer-readable medium of claim 12, further comprising:
code to cause the processor to determine a position of the HMD relative to the external camera based on a fiducial displayed by the remote computing device.
